(19) United States
(12) Patent Application Publication
(10) Pub. No.: US 2020/0140328 A1
(43) Pub. Date: May 7, 2020

(54) CONTAINER OF GLASS AND METHOD FOR ITS MANUFACTURE

(71) Applicant: SCHOTT AG, Mainz (DE)

(72) Inventors: Andreas Langsdorf, Ingelheim (DE); Stephan Tratzky, Neustadt/Wn. (DE); Florian Maurer, Griesheim (DE); Peter Thomas, Koblenz (DE)

(73) Assignee: SCHOTT AG, Mainz (DE)

(21) Appl. No.: 16/674,001

(22) Filed: Nov. 5, 2019

(30) Foreign Application Priority Data
Nov. 5, 2018 (DE) 10 2018 127 528.5

(51) Int. Cl. C03C 21/00; B65D 1/02; A61J 1/06

(52) U.S. Cl. CPC C03C 21/002; A61J 1/065; B65D 1/0207

(57) ABSTRACT

A container of glass and a method for chemically prestressing such a container of glass are provided. The container of glass includes a hollow body with an internal volume, a wall with an inside surface, which borders the internal volume of the hollow body, and an outside surface opposite the inside surface. The wall has, at least in a partial region, a zone with compressive stress formed bordering the outside surface, as a result of which the outside surface is compression-prestressed at least in a partial region. The inside surface of the wall opposite this partial region is free from compressive stresses and is under tensile stress.

### CROSS REFERENCE TO RELATED APPLICATIONS

This application claims benefit under 35 USC § 119 of German Application No. 10 2018 127 528.5 filed Nov. 5, 2018, the entire contents of which are incorporated herein by reference.

### BACKGROUND

### 1. Field of the Invention

The present invention generally relates to a container of glass, in particular comprising particular strength, preferably for receiving a preparation, in particular a cosmetic, medical or pharmaceutical preparation, as well as to a method for its manufacture.

### 2. Description of Related Art

Containers or so-called primary packagings of glass for receiving a cosmetic, medical or pharmaceutical preparation are widely known and can be made available in various geometries and quality grades. Containers of this kind are suitable for storing, transporting or even administering the preparation. They can be manufactured for example as a cartridge, small bottle or ampoule in large quantities at low cost.

Containers of this kind may be manufactured not only from glass but also from plastic for example, wherein containers of glass however have advantages for example with regard to the longevity of the packaging or potential contamination of preparations contained therein, because glass is chemically inert.

Containers of glass are generally cleaned prior to filling and then filled, sealed and transported or packed into larger containers. This is done with the aid of suitable equipment, which as a rule, operates fully automatically.

During this process the containers are subjected to special strains. During transportation, on the one hand, the containers may come into contact with, or get knocked into, each other thereby possibly also being exposed to increased forces impacting in the radial or axial direction. This in turn can lead to surface damage, for example in the form of scratches on the outer surface of the container, or even to cracks. Sometimes, larger forces or knocks can also have an impact to the extent, where a breakage of the container occurs, in particular if this is made of glass. Especially in the case of pharmaceutical primary packagings, this is a big problem, in particular with respect to the purity requirements to be observed.

A further relevant factor for a pharmaceutical container may be the internal pressure, which during filling of the container with for example liquid preparations can impact on this container. Excessive pressure during filling or during lyophilization can, in unfavourable circumstances, lead to the container exploding. This problem is compounded even further if the container has already suffered previous damage, for example, as a result of the above-mentioned forces.

The document WO 2013/130721 A1 proposes its own solution. Here a glass container of alumino-silicate glass is proposed, which has at least one prestressed sidewall. Prestressing the sidewall shall ensure, that, if a crack forms which extends through the sidewall and may endanger the sterility inside the container, the container is severely damaged to such an extent that it can no longer be used for its intended purpose. It is disclosed to therefore introduce a tensile stress into the sidewall, in particular into its central region, which lies above a threshold value of 15 MPa, and the exemplary embodiments only describe containers with compressive prestressing on the outside and the inside.

Such mutual compressive prestressing can be achieved by an ion exchange on the near-surface layer of the glass through a process which takes place in a saline bath at raised temperatures. In certain types of glass this has the effect that smaller ions, such as, for example, sodium ions, present in the near-surface layer of the glass are exchanged for larger ions, such as, for example, potassium ions, in the saline bath. This causes compressive stress in the surface region, which can lead to an increase in the strength of the glass.

During this process however, the inside surface of the glass container, that is to say therefore the surface that is later to come into contact with a filled preparation, also experiences such an ion exchange and thus also a chemical change. For certain preparations this can be disadvantageous, which means that the range of possible uses of such glass containers is limited. Frequently types of glass admissible for medical uses therefore also undergo a severe change at least on the inner surface thereof to an extent that as a result of the approval of these types of glass for these medical applications either lapses or requires renewed approval.

Furthermore methods are also known, in which further processing takes place, in particular cleaning or de-alkalization of the inside surface, downstream of the chemical prestressing process. Admittedly, due to this post-treatment it is possible to reduce the release of alkalis into a pharmaceutical, but such cleaning/de-alkalization leads to a further chemical modification of the glass surface so that here too renewed approval of the respective glass container as a pharmaceutical primary packaging means is unavoidable. Besides it is also only possible up to a shallow depth to again remove the materials introduced via the saline bath.

### SUMMARY

It is therefore the objective of the invention to provide a pharmaceutical container which, compared to standard containers which are not prestressed, possesses higher strength in relation to radial or axial forces impacting from the outside and which further comprises a higher or at least equal internal compressive strength in relation to standard containers which are not prestressed, and which shall not necessitate a renewed pharmaceutical approval process.

The invention discloses a container of glass, in particular for receiving a preparation, comprising a hollow body, which has an internal volume, in particular for receiving the preparation, wherein the hollow body comprises a wall with an inside surface, which borders the internal volume of the hollow body, as well as an outside surface opposite the inside surface, wherein the wall comprises, at least in a partial region, a zone with compressive stress, wherein the zone with the compressive stress is formed in the wall bordering the outside surface, as a result of which the outside surface is compression-prestressed at least in a partial region, and wherein the inside surface of the wall opposite this partial region is free from compressive stresses and is preferably under tensile stress.

The invention further comprises a method for chemically prestressing a container of glass, in particular for receiving a preparation, in which a hollow body defining an internal volume, in particular for receiving the preparation, and comprising a wall with an inside surface pointing towards the internal volume of the hollow body as well as an outside surface opposite the inside surface, is immersed, starting with the floor or the opening, up to an intended depth in a saline bath comprising potassium nitrate (KNO₃), preferably at a raised temperature of at least 400° C., but below the glass transition temperature (Tg) of the glass, for a duration of 1 to 24 hours, preferably of 1 to 8 hours, in order to generate compressive stress on the outside surface, at least in sections, so that the outside wall is compression-prestressed, at least in sections.

### BRIEF DESCRIPTION OF THE DRAWINGS

The invention will now be described with reference to the accompanying drawings by way of preferred embodiments, in which:

FIG. 1 shows an at least partially cross-sectional view of a container of glass according to the invention by way of an exemplary small bottle for receiving a preparation, which extends essentially vertically through the centre of the container,

FIG. 2 shows, purely schematically, a cut-out, from a cross-sectional view, of the wall of a region of the sidewall, the view extending essentially vertically through the centre of the container,

FIGS. 3-6 show results of strength tests on containers of glass, wherein unilaterally externally prestressed containers of borosilicate glass and of alumino-silicate glass are respectively compared with and analysed by containers which have not respectively been prestressed,

FIG. 7 shows, by way of example, the stress ratios across the thickness of the wall occurring as a result of unilateral prestressing,

FIG. 8 shows the pattern (of positive) compressive stress and (of negative) tensile stress in the wall by way of a stress pattern from the outside surface to the inside surface of the wall, and

FIG. 9 shows a container of glass according to the invention by way of an exemplary small bottle, wherein a plug with a stainless steel body has been inserted into the opening of the container for the fluid-tight sealing thereof, the view being an at least partial cross-sectional view, which extends essentially vertically through the middle of the container.

### DETAILED DESCRIPTION

The container, in terms of this invention, is deemed to be a vessel or a receptacle, which is suitable to receive a gaseous, solid or liquid material or a mixture from a gaseous, solid and/or liquid material. The internal volume of the hollow body of the container may be filled for example with a cosmetic, medical or pharmaceutical preparation, which preferably may be present in liquid form but also in solid form or as mixtures therefrom. A container of this kind may for example be a small bottle, an ampoule, a syringe or a cartridge.

To this end the hollow body may have a wall with an inside surface pointing towards the internal volume of the hollow body as well as an outside surface arranged opposite the inside surface, which outside surface points towards the environment. The hollow body may be of a generally rotation-symmetrical shape with an upper end and a lower end, wherein a cylindrical body area may consist of the original pipe, from which the container has been created by hot-moulding, and may preferably comprise an opening for filling or emptying the hollow body. This opening may be arranged at the upper end.

The wall of the hollow body, in a preferred embodiment such as in the case of a small bottle, may comprise a sidewall and a floor as well as a rounded-off edge which forms between floor and sidewall, and represents the transition area between sidewall and floor, and which, in the following, is also called a heel. The floor forms herein the lower end of the hollow body. With small bottles a shoulder adjoining the sidewall may be provided in the direction of the lower end, which shoulder may transition into a neck and comprise a termination at the upper end. Neck and termination preferably comprise a passage, which represents the opening to the internal volume of the hollow body. The upper termination, especially in the case of primary packagings such as a cartridge or a small bottle, is also called a rolled edging and is arranged opposite the floor.

Insofar as in terms of the description of the invention the terms “top” or “bottom” are used in relation to the container, this means the upper end and the lower end of the hollow body or of the container, as can be recognized in the drawings. In this context the term “inside” refers to areas or surfaces of the hollow body or container, which may be regarded as pointing towards the internal volume of the hollow body and the term “outside” refers to those areas or surfaces of the hollow body or container, which point towards the environment. Insofar as the term “radial direction” is used in terms of the present disclosure, this refers to cylinder-symmetrical containers, for which this is unequivocally defined. Should the container comprise a non-cylinder-symmetrical shape or deviations from a cylinder-symmetrical shape, this term “radial direction” defines a direction, which extends perpendicularly from the outside surface of the container to the inside surface of the container. The expression “within a region remote by 0.5 μm from the outside surface up to a region remote by 0.5 μm from the inside surface” refers to a region of a straight line extending in radial direction from the outside surface to the inside surface. Insofar as in terms of the present disclosure reference is made to the middle of the wall, this denotes the middle between the outside surface and the inside surface on the above-mentioned straight line.

A container of glass of this kind may for example be manufactured from sections of a drawn glass tube by means of subsequent hot-moulding. Glass compositions, preferably borosilicate glass or alumino-silicate glass, suitable for pharmaceutical primary packagings may be chosen here.

According to the invention the outside surface of the wall may comprise an externally arranged layer or zone with compressive stress, so that the wall on the outside is compression-prestressed, at least in sections. In other words, the wall of the container may, at least in sections, comprise unilateral external compressive prestressing. This means that the wall on its outside surface comprises at least one layer or zone, which reaches into the wall up to a certain depth and has a compressive stress which is different from the stress in the remaining wall, in particular the inside surface of the wall opposite the outside surface.

Preferably the compressive stress on the outside surface of the wall of the hollow body is thus higher than the stress on the opposite inside surface of the wall. Especially preferably a tensile stress counteracting the compressive stress is present on the inside surface of the wall opposite the compressive prestressing on the outside. A container can thus be made available, which comprises a hollow body with a wall, which is prestressed on the outside, i.e. on one side.

This compressive prestressing, also called prestressing, can be generated thermally or preferably chemically.

Thermal prestressing of the container can advantageously be employed as from a glass thickness of approximately 3 mm. During this process the glass is initially heated consistently in an oven up to a temperature of above 600° C. followed by having cold air blown at it, so that it cools down rapidly. Due to this defined process a compressive stress zone develops on the surfaces of the glass, which zone encloses a tensile stress zone present in the core of the glass. Due to this defined stress ratio a thermally prestressed glass comprises a mechanical and thermal strength which is higher by a factor of 3 to 4 than a glass which is not prestressed. Since containers of glass used especially in the pharmaceutical field generally have a wall thickness of less than 3 mm, this method of inventive prestressing is less suitable, especially with containers of glass with a wall thickness of less than 3 mm.

By contrast the situation is different with chemical prestressing, where practically no such limits apply as regards the wall width, i.e. the thickness of the wall of the glass to be chemically prestressed. Chemical compression stressing of the container may be carried out by subjecting the container to a raised temperature of approximately 400° C. or more and immersing it in a saline bath containing potassium nitrate (KNO₃). The temperature should however in this case remain below the Tg of the glass, in order not to allow any significant relaxation to occur, so that stresses can be formed in a defined manner, but it should be high enough so that a sufficiently quick and deep ion exchange can take place in the surface.

It is possible also for the chemical hardening process to take place successively in different saline baths of this kind, wherein the introduction into the saline bath takes place over a duration of approximately 1 to 24 hours, preferably over a duration of 1 to 8 hours.

With this chemical prestressing method smaller sodium ions from the near-surface layer of the glass may be exchanged for larger potassium ions from the saline bath. The larger potassium ions are introduced into the network of the glass, which causes a near-surface layer or zone with compressive stress to develop. The correspondingly treated surface herein undergoes an enrichment with potassium ions as well as a depletion of sodium ions and as a result this surface comprises a higher content of potassium ions than the original glass. The maximum compressive stress CS may herein occur on the surface or may occur also below the compression-prestressed surface.

The depth or thickness of the prestressed layer on the outside surface of the wall is generally also called DOL (depth of layer). This thickness DOL may be determined by means of a photo-elastic zero passage measuring process, for example by means of a measuring device with the trade name FSM-6000.

This measuring device can also be used to determine the compressive stress of the surface as well as the maximum compressive stress CS of a pane. The thickness of the prestressed layer DOL as a rule corresponds approximately to the depth of penetration of the larger ions from the saline bath into the glass surface.

Insofar as the term “alkalis” is used hereinafter, these are thus to be understood to mean in particular the elements potassium and sodium or their ions in the glass, wherein, when they are mentioned hereunder, the values converted for oxides are disclosed, respectively.

Inside the glass, i.e. starting from the outside surface in a direction perpendicular to the surface, a tensile stress in the opposite direction to the compressive stress develops by way of the prestressing, which adjoins the compressive stress zone as from the above-mentioned depth DOL thereof. With glass prestressed on both sides this may apply in particular to the central region of the wall, so that a central wall region with tensile stress is respectively surrounded on both sides by a region with increased compressive stress of the respective depth DOL, as for example described in WO 2013/130721 A1. In this publication CT herein denotes the value of the tensile stress in the central wall region, where the tensile stress is also the highest when prestressing has taken place on both sides. With the unilateral outside prestressing according to the invention the tensile stress CT then continues as far as the inside surface of the wall, where in terms of the present disclosure this is denoted with IST and CT does not necessarily indicate the maximum value of the tensile stress. The outside surfaces of the wall therefore, for glass prestressed on both sides, are respectively under increased compressive stress, whereas in the central region of the wall a tensile stress acting in the opposite direction is dominant.

Under the invention it is provided to prestress merely the outside surface of the wall, at least in sections, but not thus the inside surface of the wall.

Unexpectedly and surprisingly, a container of glass compression-prestressed on one side only on the outside comprises significantly improved strength, in particular also when impacted from the outside by certain forces and also in the case of loads to which the container is exposed for instance during filling and transportation.

This includes in particular improved strength during filling and/or sealing, which can be problematic above all in the case of brittle-hard materials such as glass, as well as however good strength for axially or radially impacting forces (side compression) or knocks, which can occur for instance during automatic transportation.

Improved strength of the container with unilateral prestress was not to be expected insofar as it had to be assumed that, in conjunction with the tensile stresses due to the unilateral external compressive prestress, additional tensile stresses which have an adding effect impact the wall of the hollow body in the above-described load situations of the container, so that ultimately strength was not to be expected to increase but rather to decrease.

Completely unexpectedly it is now evident that with externally compression-prestressed containers of glass the burst pressure remains substantially unchanged, wherein at the same time the strength can even be distinctly increased against external forces impacting the container, such as in the case of axial and radial compression or knocks.

In order to understand this unexpected material behaviour of the container of glass prestressed unilaterally on the outside, structure-mechanical modelling with respective simulations was performed in order to better understand the stress patterns arising as a result of this unilateral prestressing. The investigation shows that in this case, i.e. for a container prestressed on the outside, the tensile stress CT existent generally in the central region of the glass continues as far as the inside surface of the wall of the hollow body, where this is then also called, for example, inner surface tension or abbreviated to IST.

Estimating the level of this tensile stress IST is therefore no longer possible on the basis of the generally known rule for estimating the tensile stress CT in glass prestressed on both sides, which is:

CT=(CS×DOL)/(t−2DOL)

Herein t denotes the wall thickness, and it is assumed that the tension equalization based on the ratio between a central tensile stress zone CT×(t−2DOL) and two adjacent outer compressive stress zones 2×½(CS×DOL)] can be respectively derived from the product thereof of the extension depth of the respectively increased stress multiplied by the increased stress, so that for an equalization or in the equilibrium of the outer compressive stress with the inner tensile stress the following applies:

CT×(t−2DOL)=2×½(CS×DOL)

By contrast the tensile stress according to the invention on the inside surface IST (inner surface tension) is derived from the tension equalization between a single tensile stress zone and merely one single compressive stress zone, so that for the state of equilibrium given that the introduced stresses have been equalized, the following applies approximately:

IST×(t−DOL)=½(CS×DOL)

Consequently, the following applies for the inventive tension distribution in the wall of the hollow body of the container:

IST=0.5×(CS×DOL)/(t−DOL),

wherein CS describes the maximum compressive stress introduced in the region of the outside surface, which compressive stress was generated by the compressive stress zone arranged in the vicinity of, or adjacent to, the outside surface, respectively, DOL describes the depth of this compressive stress zone starting from the outside surface and t describes the thickness of the wall, into which the compressive stress zone was introduced.

With the unilateral external prestressing according to the invention the tensile stress CT now continues as far as the inside surface of the wall, where this, in terms of the present disclosure, is denoted with IST.

Given this tension pattern inside the wall of the container, the inventors were then able to achieve a very advantageous equalization between increasing the strength of the container and preventing deteriorations, such as for example deteriorations of the internal compressive strength of the container, and thus of the properties of the container in relation to burst pressures.

For example, excessive tensile stress with unilateral prestressing may lead, in load cases which are linked to very high tensile stress loading upon the inside surface, to a deterioration of the strength of the container. On the other hand, greater strength can however be achieved in relation to externally impacting forces, such as for an axial or radial impact of forces or also for knocks from the outside against the container of glass.

Even if the burst pressure, i.e. the magnitude of the tensile stresses sustainable to a maximum extent on the inside surface, cannot be increased, the increase in strength in relation to axial and radial forces nevertheless has an impact on the performance characteristics of the container.

In order to verify the results obtained by means of the structure-mechanical modelling, strength tests were carried out on containers of glass. To this end containers of uniform geometry, in the example containers with a nominal volume of 2 ml (2R vials), both of borosilicate glass and of alumino-silicate glass, were subjected to respective tests, wherein test batches of 50 containers each were formed.

The tests were performed by unilaterally chemically externally prestressing the containers with a wall thickness t of 1 mm in the tubular or cylindrical region thereof of the sidewall. In the case of borosilicate glass a compression-prestressed surface layer was produced with compression prestressing of approximately CS=200 MPa and a thickness of the prestressed layer, i.e. the prestressed depth, of approximately DOL=35 μm. In the case of alumino-silicate glass a compression-prestressed surface layer was produced with compression prestressing of approximately CS=800 MPa and a prestressed depth of approximately DOL=55 μm. Samples of identical material and identical geometry were used for comparison, which were not prestressed.

The strength during filling was determined with the aid of the burst test, in order to ascertain the so-called burst pressure. This burst test is a destructive test for determining the burst pressure of hollow bodies. It serves to ascertain the maximum sustainable tensile stresses.

The above-mentioned samples were subjected to both these burst pressure tests and to axial and diametrical or radial compression impact as well as to a pendulum impact test for examining the behaviour in the case of knocks.

During these tests it could be proven that the burst pressure resistance in the case of a unilaterally externally prestressed container of borosilicate glass remains practically unchanged, whereas in the case of a unilaterally externally prestressed container of alumino-silicate glass it noticeably decreases.

With all other three tests, i.e. with axial compression and diametrical or radial compression impact of the container as well as when performing the pendulum impact test, distinct improvements in strength could be found.

In the case of axial and radial or diametrical compression a container comprising alumino-silicate glass with unilateral external prestressing shows an increase in strength relative to an equivalent, not prestressed container which is of the magnitude of a unilaterally externally prestressed container of borosilicate glass.

In the case of containers of borosilicate glass less compression prestressing on the surface is by contrast sufficient in order to achieve a significant increase in strength in relation to the three last-mentioned load cases without suffering any deterioration in burst pressure resistance. Thus the invention is suitable in particular for containers which comprise borosilicate glass or are manufactured from the same.

The development of tensile stress on the inside surface of the wall is therefore an essential characteristic for the strength of the container, in particular in the case of external knocks, or axially or radially impacting forces, the magnitude of which has a critical influence on the strength. In terms of the invention care must be taken to ensure that an optimum exists as regards the tensile stress, which if exceeded causes the surface on the inside surface of the wall to be weakened, but if not reached does not achieve a sufficiently high improvement in strength of the outer surface of the wall of the hollow body.

In summary, the unilateral external prestressing of the container of glass according to the invention has the effect that the inside surface of the container, that is to say the surface of the wall pointing towards the internal volume and thus able to come into contact with a filled-in preparation, does not have a compression-prestressed layer. Rather the tensile stress in the opposite direction to the compressive stress and normally dominating in the centre of a bilaterally prestressed glass pane, may reach beyond the centre of the wall of the container according to the invention as far as the inside surface of the wall. Therefore a (small) tensile stress is preferably present on the inside surface of the wall.

In other words an asymmetric profile of the prestress pattern in the wall develops, wherein the outer half of the wall, on average, comprises a (positive) compressive stress and the inner half of the wall, on average, comprises a (negative) tensile stress. The inner tensile stress however is herein distinctly less than the outer compressive stress.

In a preferred embodiment and based on this stress pattern in the wall a container of glass may be made available which has a hollow body with comparatively high compression prestressing on the outside surface and in comparison thereto little tensile stress in its centre and on its inside surface, and wherein:

IST<0.8*(CS×DOL)/(t−2DOL); and/or

0.3*(CS×DOL)/(t−DOL)<IST<0.7*(CS×DOL)/(t−DOL)

In a further preferred embodiment a container of glass may be made available with a tension on the inside surface of the wall IST, preferably opposite the region with compression prestressing on the outside surface, of IST>=0 MPa and IST<=30 MPa, preferably IST<=20 MPa, especially preferably IST<=15 MPa and most especially preferably IST<=5 MPa. In this way it can be ensured that the tensile stress due to the prestressing does not increase too much so that the burst behaviour of the container hardly deteriorates or preferably does not deteriorate at all, i.e. the burst resistance is preferably maintained.

The tensile stress pattern may herein be relatively constant from the middle of the wall of the inventive container as far as the inside surface of the wall, i.e. the level of tensile stress in the middle of the wall is approximately equal to the level of tensile stress on the inside surface of the wall in the said region. In a preferred embodiment the level of tensile stress in the middle of the wall up to the inside surface of the wall is subject to merely a small fluctuation, which is preferably within a range of +/−10%, preferably of +/−5%.

The container according to the invention is therefore also characterized in that only one side of the wall, preferably only the outside surface of the wall, comprises a near-surface compression-prestressed zone with a thickness, which is not more than 15% relative to the wall thickness, preferably not more than 10% and especially preferably not more than 8%.

In a most particularly preferred embodiment the thickness of the near-surface compression-prestressed zone on the outside surface of the wall is not more than 6% relative to the thickness of the wall. For a wall thickness of e.g. t=1.6 mm the thickness of the near-surface compression-prestressed zone is therefore approximately DOL=96 μm. As a result it can be achieved with a high degree of reliability that, with chemical prestressing in particular, that region which, due to the prestressing, undergoes a change in its composition and is enriched with potassium ions is only the outside surface.

The central region of the wall and an inner region extending from the middle of the wall up to the inside surface of the wall are therefore preferably free from additional alkalis, preferably potassium ions, introduced by the prestressing. Generally speaking, a distribution of alkalis introduced by the prestressing is such that it monotonously decreases from the outside surface towards the inside surface of the wall, within a region remote by 0.5 μm from the outside surface up to a region remote by 0.5 μm from the inside surface, wherein for this statement integration extended over a depth of e.g. 100 μm or even only 10 μm, since for example a leaching process, such as with ABF (ammonium bifluoride), can get rid again of the alkalis in the innermost very thin layer.

On the inside surface of the wall the amount of K₂O and Na₂O, averaged up to a depth of 500 μm, is therefore preferably not more than 10% by weight, especially not more than 9% and especially preferably not more than 8%. According to the invention this amount is measured on the inside surface of the wall at a medium height viewed from the floor.

To sum up therefore, following the chemical prestressing, a concentration pattern of alkalis exchanged during the chemical prestressing prevails, which pattern starting from a high value close to the outside surface of the wall decreases to a low glass immanent value close to or at the inside surface of essentially zero or equal to zero.

Thus a big advantage of the invention is seen in that the inside surface of the container which interacts with the medicine remains chemically unaltered. This is advantageous in particular for containers which are intended to receive a cosmetic, medical or pharmaceutical preparation. At the same time the strength of the container according to the invention can be improved so that the product reliability of the container, in particular during transport and/or filling, can be distinctly improved. Also when sealing the container for example with a closure such as a plug, high internal pressures can occur which can lead to bursting. Here too the reliability of the container according to the invention can be improved.

This advantage is particularly noticeable with containers of borosilicate glass, since this type of glass does not require chemical pre-treatment of the glass in order to achieve the required chemical stability. However, if, as is generally usual, the inside surface of the wall of the hollow body is also chemically prestressed here, alkalis, i.e. potassium ions from the saline bath, are introduced there in high concentration as a replacement for sodium ions of the glass. This takes place typically up to a depth of a few ten μm viewed from the inside surface. It is albeit possible by means of a chemical post-treatment to again remove these alkalis to a small extent. However, this requires, on the one hand, an additional processing step, whilst on the other hand, this is also only successful in the outermost surface layer. Furthermore, the alkali discharge on the inside surface following post-treatment depends of course strongly on the intensity of the post-treatment with the parameters time duration, temperature, pH-value, etc., but may also furthermore depend on factors such as the container geometry. Thus a chemically prestressed and post-treated inside surface cannot be presumed to be a glass surface with substantially constant chemical properties, as is the case with a chemically not prestressed glass surface.

According to the invention, on the one hand a chemical post-treatment of the inside surface may be waived in an advantageous manner, on the other hand, the inside surface of the wall of the container, even up to larger depths measured from the inside surface of the wall, is predominantly quite free from alkalis introduced by way of the chemical prestressing.

In this way, an improved pharmaceutical primary packaging of glass can be offered with regard to strength, preferably comprising alumino-silicate glass or borosilicate glass, where the inside surface of the wall of the container, which comes into contact with the preparation, for example the medicine, up to a depth of 100 μm, preferably up to 150 μm and especially preferably up to 200 μm, measured from the inside surface perpendicular to the depth of the wall, does not have to comprise any alkali concentrations changed by chemical prestressing with regard to the glass, e.g. the bulk glass in the middle of the wall of the container. Preferably there is also therefore in this region, as a rule, no increased concentration of potassium ions with regard to the bulk glass.

Further, according to the invention an improved pharmaceutical primary packaging of borosilicate glass can be offered with regard to strength, where the inside surface of the wall of the container, which comes into contact with the preparation, for example the medicine, is chemically unchanged compared to the surface of a not prestressed container. The preparation, for example the medicine, is therefore, as before, only in contact with the original borosilicate glass surface.

In terms of the invention it is provided to increase the strength of the container of glass by means of unilateral external prestressing preferably there, where principally the critical loads occur. In general this refers to regions of the surface on the outside surface of the wall, preferably in the region of the sidewall. Further it seems convenient to also prestress the floor or at least the heel unilaterally externally, where from experience the largest loads occur. This may also include an inside thickening of the glass in the region, in order to alleviate or even avoid a possibly occurring increase in tensile stresses, which are generated through compressive stress zones in the region of the heel.

In a further development of the invention it is provided that further regions of the outside wall of the container are also unilaterally externally prestressed, for example those regions of the outside wall, which adjoin above the sidewall of the hollow body. In the case of small bottles these regions may be the shoulder and/or the neck and/or the rolled edging of the hollow body.

Advantageously a container comprising glass or consisting of glass, in particular for receiving a preparation, is further disclosed comprising a hollow body which has an internal volume, in particular for receiving the preparation, wherein the hollow body comprises a wall with an inside surface, which borders the internal volume of the hollow body, as well as an outside surface opposite the inside surface, wherein the wall, at least in a partial region, comprises a zone with compressive stress, wherein the zone with the compressive stress is formed in the wall bordering the outside surface, and wherein in the middle of the wall, i.e. in the middle between the outside surface and the inside surface the tensile stress CT is expressed as CT>=0 MPa and CT<=20 MPa, preferably CT<=15 MPa and especially preferably CT<=5 MPa. Using this design is for the purpose to safely avoid an occurrence of a burst behaviour as described in WO 2013/130721 A1.

Advantageously the wall of the hollow body forms at least one opening, and/or a rolled edging and/or a neck and/or a shoulder and/or a sidewall and/or a heel and/or a floor.

When a or the zone comprising compressive stress is formed, respectively, adjacent to the shoulder, the neck, the rolled edging, the sidewall, the heel and/or the floor and/or bordering the shoulder, the neck, the rolled edging, the sidewall, the heel and/or the floor, the strength properties of the container can as a result be advantageously adapted to the respective requirements with regard to its mechanical load.

When due to the zone with the compressive stress, which is formed in the wall bordering the outside surface, compressive stresses are formed in the region of the outside surface, are formed in particular up to a depth DOL, and in the radial direction with regard to the middle of the wall an asymmetric profile of the stress pattern exists from the outside surface to the opposite inside surface in the wall, substantial advantages can be gained with regard to symmetrical prestressing, such as for example a considerable increase in strength without however having to accept substantial disadvantages here with regard to the burst pressure resistance.

Advantageously it may be true to state here that in the region with compressive stresses in the outside surface, the tension IST (inner surface tension) is formed as tensile stress on the inside surface of the wall opposite this region and this tensile stress IST is expressed as: IST>=0 MPa and IST<=30 MPa, preferably IST<=20 MPa, especially preferably IST<=15 MPa and most especially preferably IST<=5 MPa.

With an especially preferred embodiment in the region with compressive stresses in the outside surface the tension, in particular tensile stress on the opposite inside surface of the wall, is expressed as:

0.3*(CS×DOL)/(t−DOL)<IST<0.7*(CS×DOL)/(t−DOL),

wherein DOL denotes the depth of the zone, in which compressive stresses exist, t denotes the thickness of the wall, and
CS denotes the stresses, in particular compressive stresses on the outside surface.

The inventors have discovered that in the region with compressive stresses in the outside surface the level of tensile stress in the middle of the wall is approximately equal to the level of tensile stress on the opposite inside surface of the wall, and wherein preferably the level of tensile stress in the middle of the wall up to the inside surface of the wall is subject to merely a small fluctuation within a range of +/−10%, preferably of +/−5%. As a result a stress, in particular tensile stress, which is consistent across a large region of the wall of the container is provided, which stress avoids tension peaks and an accompanying reduction in the burst pressure resistance.

Advantageously, for the region with compressive stress in the outside surface the near-surface compression-prestressed zone has a thickness or depth DOL, which is not more than 15% in regard to the thickness of the wall or wall width in this region, preferably not more than 10% and especially preferably not more than 8% and most especially preferably not more than 6%.

Preferably with chemically introduced prestressing in the zone with compressive stress the distribution of alkalis introduced into the glass during the chemical prestressing is monotonously decreasing directly after the chemical prestressing from the outside surface towards the opposite inside surface of the wall, at least within a region remote by 0.5 μm from the outside surface up to a region remote by 0.5 μm from the inside surface.

Under these circumstances, at least in the region with compressive stress in the outside surface the glass on the opposite inside surface of the wall of up to a depth of 100 μm, preferably up to 150 μm and especially preferably up to 200 μm, may not comprise a concentration, additionally introduced into the glass, of an alkali species in regard to the glass in the middle of the wall, so that chemical prestressing does not negatively impact the use of the container for medical applications.

In a preferred embodiment at least on the inside surface of the wall opposite the region with compressive stress the average content of K₂O and Na₂O up to a depth of 500 μm is not more than 13% by weight, preferably not more than 9% and especially preferably not more than 8%.

Depending on the provided amount of the prestressing, various embodiments are suitable for the method. If only the floor and/or the heel and/or the sidewall are for instance to be chemically unilaterally externally prestressed, it is thus obvious to immerse the container, starting with the floor, in the saline bath. If the regions of the container adjoining from above shall also further be chemically unilaterally externally prestressed, the container can, starting with the floor, be immersed to a greater depth in the saline bath, wherein however care should be taken that the saline bath does not enter into the opening so as to prevent the inside surface of the container from being chemically changed. To this end it is for example possible to seal the opening with a plug, so that it is then possible to also submerge the container completely.

Another embodiment provides for the container to be immersed, head first, in a direction of movement parallel to the longitudinal axis of the container and perpendicular to the surface of the saline bath, so that due to the air present in the hollow body the saline solution can be prevented from entering the hollow body. The disadvantage with this method is that vapours from the saline bath can get into the opening if this opening was not properly sealed in advance.

For better understanding the following definitions are given below.

The word zone in terms of the present disclosure is understood to mean a spatial volume, which is totally inside the glass, but can border its surfaces. The word surface in terms of the present disclosure is understood to refer to, not the mathematical concept of a surface, but the physical concept, where this comprises at least one or more atomic or molecular layers of the glass such that their physical properties, such as for example compressive stresses or tensile stresses, are measurable, for example in the inside surface and the outside surface.

The concept of a layer may comprise the above-mentioned zone and conceptually coincide with the same when this zone extends for example near the surface along a surface, for example the outside surface, and thereby occupies a spatial volume. In this case the concepts of zone and layer are used synonymously, although this kind of layer as a rule consists of intrinsic material of the glass, which can however be thermally or chemically treated.

Referring now to the drawings, in the preferred embodiments disclosed herein identical reference symbols denote, for sake of simplicity, essentially identical parts in or on these embodiments.

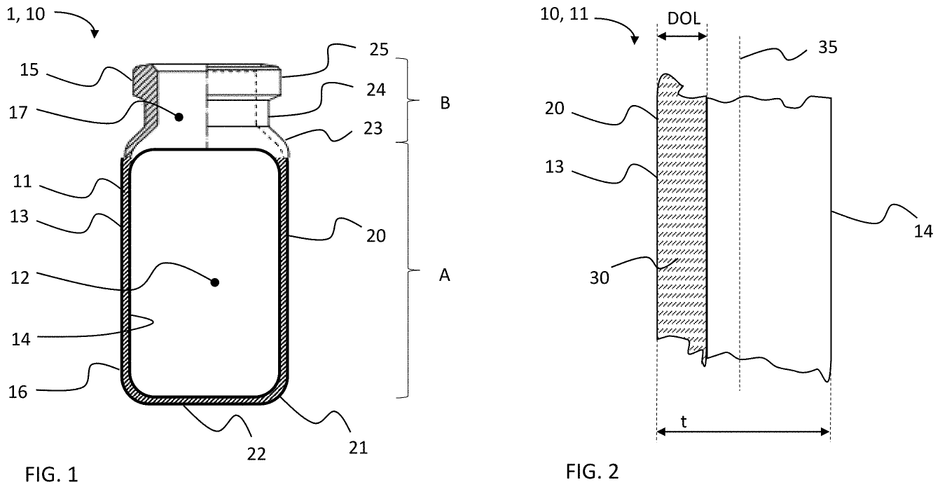

FIG. 1 shows a container 1 of glass according to the invention by way of an exemplary small bottle 10 for receiving a preparation (not shown). The container 1 comprises a hollow body, which defines an internal volume 12 for receiving the preparation. The container 1 can also of course, without any restriction to the exemplary embodiment depicted, comprise other geometric shapes comprising an ampoule, a syringe or a cartridge.

The hollow body comprises a wall 11 with an inside surface 14, which points towards the internal volume 12 of the hollow body, as well as an outside surface 13 arranged opposite the inside surface 14, which outside surface points towards the environment. The rotation-symmetric hollow body comprises a cylindrical or tubular portion with an upper end 15 and a lower end 16 and comprises, at its upper end 15, an opening 17 for filling or emptying the hollow body.

In the exemplary small bottle 10 depicted the wall 11 of the hollow body comprises a sidewall 20 and a floor 22 and, in the transitional region between floor 22 and sidewall 20, a rounded-off edge, which is denoted as heel 21. The floor therefore forms the lower end of the hollow body. In the example of the small bottle 10 a shoulder 23 forms the upper termination of the sidewall 20. This changes to become a neck 24, which at the upper end 15 is finally adjoined by a termination, which in the example of the small bottle 10 is also denoted as rolled edging 25. The person skilled in the art will recognize that these notations of the wall 11 relate to the depicted small bottle 10 and in the case of other shapes of the container, such as when depicted as an ampoule, syringe or cartridge, other notations prevail. The unilateral external prestressing according to the invention therefore naturally refers not only to small bottles but generally to containers of glass of varying geometries.

Independently of the concrete geometric design of the container 1 a lower portion A of the container can be defined, which comprises a region starting from the lower end 16 of the container and essentially the region of the hollow body forming the internal volume, as well as an adjoining portion B which refers to the upper region of the container.

The depicted small bottle 10 is manufactured from a section of a drawn glass tube by means of subsequent hot-moulding. In the example, the small bottle 10 is made of borosilicate glass, wherein however other glass compositions suitable for instance for pharmaceutical primary packagings such as alumino-silicate glass can also be chosen.

Borosilicate glass has a high hydrolytic resistance to chemical leaching, and with regard to pharmaceutical applications, for example as defined in the European Pharmacopoeia 8.4, containers made of borosilicate glass are advantageously classed as corresponding to type I, that thus is the class corresponding to the highest resistance.

According to the invention the outside surface 13 of the wall 11 comprises an externally arranged layer or zone which comprises compressive stress, so that the wall 11 is compression-prestressed from the outside, at least in sections. This zone with compressive stress extends into the wall 11 up to a certain depth DOL, which wall itself comprises the thickness t.

FIG. 2 purely schematically shows a cut-out of the wall 11, in the example a region of the sidewall 20 with an outside surface 13 and an inside surface 14. Starting from the outside surface 13 of the wall 11 this is adjoined, in the direction of the middle 35 of the wall 11, by the zone 30 with the compression prestressing. It can be clearly seen that this zone 30 does not extend as far as the middle 35 of the wall 11, and in particular that region of the wall 11 which lies between the middle 35 of the wall and the inside surface 14. From this it follows that there is no compressive stress, but rather a tensile stress on the opposite inside surface 14 of the wall. It is thus evident that this is a unilaterally externally prestressed container according to the invention.

Thus only those regions of the container 1 are preferably provided with unilateral external compression prestressing, which are primarily exposed to the critical loads.

In many cases, as illustrated by way of the example of FIG. 2, this concerns the sidewall 20, because this is where knocks and radial loads can occur, especially during transport. During filling higher compressive forces may be added, which impact the interior of the container 1, and also axial loads such as during sealing. In the light of this it is obvious to also provide the wall 11 with unilateral external compression prestressing according to the invention in the region of the heel 21 and the floor 22, i.e. the portion of the container 1 marked by A.

In many cases it is convenient to provide the entire external area of the container, i.e. also the regions belonging to the portion B, including the shoulder 23, the neck 24 and the rolled edging 25 with unilateral external compressive prestressing according to the invention.

The wall thickness t of the container 1 in FIG. 2 is not restricted to the exemplary embodiment at approximately t=1 mm, but a thickness of for example t=1.6 mm is also possible. In this regard thermal prestressing is difficult to achieve, so that this small bottle 10 is chemically prestressed. To this end the container 1 is exposed to a saline bath comprising potassium nitrate (KNO₃) at a raised temperature of approximately 400° C. or more for a duration of 1 to 24 hours, or possibly 1-8 hours. This temperature should however herein respectively remain below the glass temperature Tg of the glass and can however, for example for certain types of glass, also be 450° C. or even 490° C.

The chemical prestressing leads to an enrichment of potassium ions from the saline bath instead and at the point of smaller sodium ions, present in the glass in the near-surface layer of the glass. This near-surface layer represents the zone 30. Following the chemical prestressing this layer and thus the outside surface 13 of the container 1 has a higher strength than an untreated surface.

Inside the wall 11, i.e. starting from the outside surface 13 in the direction of the inside surface 14, a tensile stress develops due to the external prestressing, which counteracts the compressive stress.

The thickness of the prestressed layer on the outside surface 13 of the wall 11, i.e. the DOL, is indicated in FIG. 2, wherein the actual thickness was chosen purely for reasons of better illustration. In reality the DOL is generally a few ten micrometres, in the example approximately 35 μm, wherein a range from 10 μm to 100 μm is generally regarded as suitable.

The unilaterally externally prestressed container 1 comprises improved strength during filling and/or sealing, and in addition good strength also in the face of axially or radially impacting forces or knocks, such as can occur for instance during automatic transport.

Using structure-mechanical modelling in conjunction with appropriate simulations it could be demonstrated that due to the unilateral prestressing the tensile stress generally existing in the central region of the glass continues as far as the inside surface of the wall of the hollow body. The tension distribution in the wall 11 of the hollow body of the container 1 according to the invention is expressed as:

IST=0.5×(CS×DOL)/(t−DOL)

wherein t denotes the thickness of the wall.

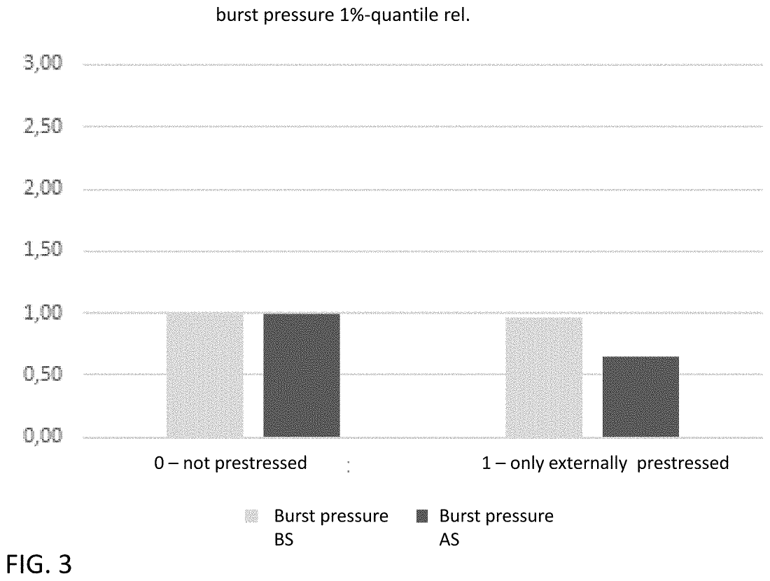

FIGS. 3 to 7 show results of strength tests on containers 1 of glass, wherein according to the invention unilaterally externally prestressed containers 1, each with a nominal volume of 2 ml (2R vials), of both borosilicate glass and alumino-silicate glass were subjected to various tests, with test batches of respectively 50 containers having been formed. In the case of borosilicate glass a compression-prestressed surface layer with maximum compression prestressing of approximately CS=200 MPa with a DOL=35 μm was produced. In the case of alumino-silicate glass a compression-prestressed surface layer with maximum compression prestressing of approximately CS=800 MPa and a DOL=55 μm was produced. These were compared to samples of identical material and identical geometry.

Borosilicate glasses are understood here by the person skilled in the art in particular as being glasses with the following components (in % by weight):

| | |
|---|---|
| SiO₂ | 65-85 |
| B₂O₃ | 5-15 |
| Na₂O + K₂O | 3.5-9 |
| Al₂O₃ | 0-7 |
| CaO | 0-3 |

Alumino-silicate glasses can preferably be of the following composition in % by weight:

| | |
|---|---|
| SiO₂ | 55 to 75 |
| Na₂O | more than 7 to 17 |
| Al₂O₃ | 8 to 20 |
| K₂O | 0 to 4 |
| MgO | 0 to 5 |
| ZrO₂ | 0 to 5 |
| ZnO | 0 to 4 |
| CaO | 0 to 10 |
| Na₂O + K₂O + MgO + ZnO + CaO | 13 to 28 |
| SnO₂ | 0 to 1 |
| TiO₂ + CeO₂ | less than or equal to 1. |

| | | burst | axial | diametric | pendulum |
|---|---|---|---|---|---|
| | glass | pressure | compression | compression | impact |
| only | BS | 0.96 | 1.58 | 2.13 | 2.56 |
| externally | | | | | |
| prestressed | | | | | |
| only | AS | 0.64 | 1.51 | 2.52 | 6.40 |
| externally | | | | | |
| prestressed | | | | | |

The above figures show the relative improvement of the 1% quantile based on external prestressing compared to the 1% quantile of the respectively not prestressed container. The abbreviation BS denotes here borosilicate glass and the abbreviation AS denotes alumino-silicate glass. The details given above are thus a relative measure for the improved properties of a container according to the invention in comparison to a conventional not prestressed container.

The determination of the burst pressure is carried out by means of a test procedure according to DIN EN ISO 7458 (“Glass containers—internal pressure resistance—Test methods”). This involves subjecting the container to a hydraulic pressure inside the container. This pressure is continuously increased at a rate of 5.8 bar per second until breakage of the container occurs.

The mechanical resistance of the container to axial compression is determined by a test procedure according to DIN EN ISO 8113 (“Glass containers—Resistance to vertical load—Test methods”). This involves subjecting the container to a compressive force in the axial direction, which is increased at a constant rate of 500 N per minute until breakage of the container occurs.

The mechanical resistance to radial or diametrical compression is also ascertained in a test procedure according to DIN EN ISO 8113.

The pendulum impact test is described in DIN 52295.

The strength during filling and/or sealing and/or lyophilization was determined with the aid of the burst test, in order to ascertain the so-called burst pressure. During these burst tests the internal pressure was increased to a severe extent where bursting of the respective container occurred. FIG. 3 shows results of this burst test. The drawing respectively shows the 1% quantile, wherein the 1% quantile of a not prestressed container of borosilicate glass was normalized to 1 in each test. It is evident that in the case of containers of borosilicate glass the burst pressure resistance in the case of a unilaterally externally prestressed container of borosilicate glass remains practically unchanged, whereas in the case of a unilaterally externally prestressed container of alumino-silicate glass it diminishes.

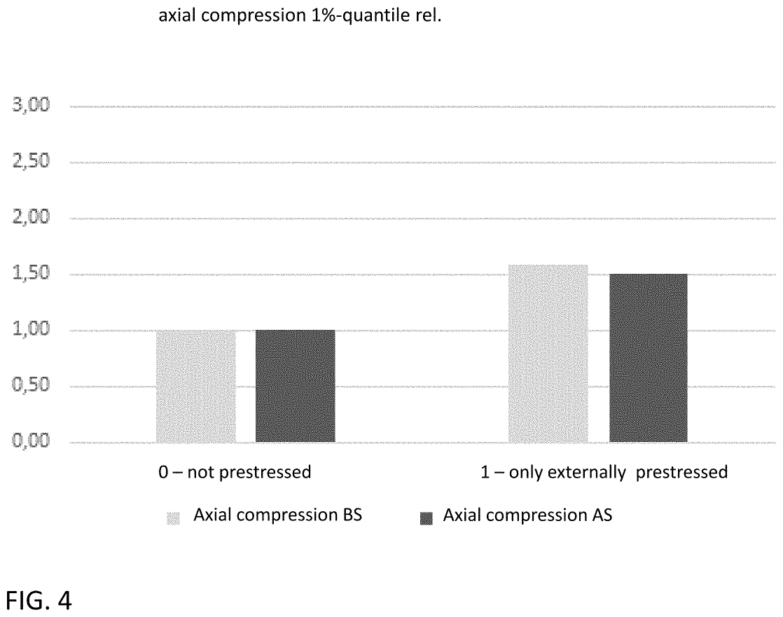

The result of the test for an axial load case such as could occur for instance during filling of the container is depicted in FIG. 4. Again the 1% quantiles have been indicated, respectively. It is evident here that the unilateral external prestressing of the container of borosilicate glass according to the invention leads to a distinct increase in strength of the container. However, in comparison to a container of alumino-silicate glass which also experiences an increase in strength, the increase in strength is higher in a container of borosilicate glass.

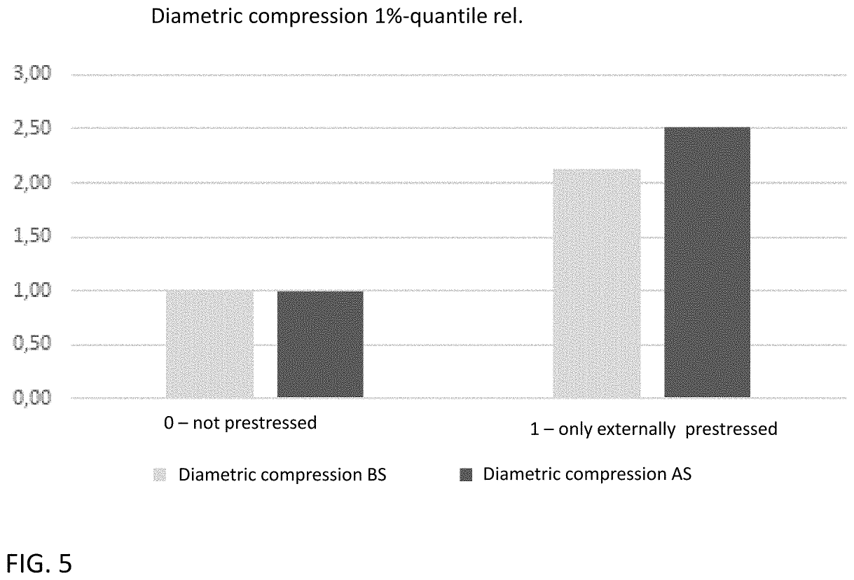

The result of the test for a diametrical load case, i.e. for a force which radially impacts the outside surface of the container such as can for instance occur during transport, is shown in FIG. 5. Again the respective 1% quantiles have been indicated. It is evident here that the unilateral external prestressing of the container of borosilicate glass according to the invention also leads to a very distinct increase in strength of the container.

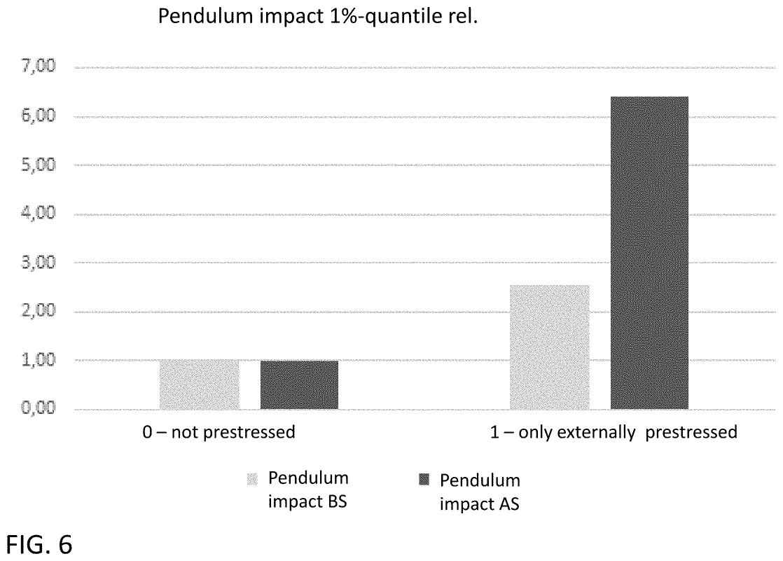

The result of the pendulum impact test, i.e. for a load as can be imposed on the container due to knocks, is shown in FIG. 6, indicated respectively in the form of 1% quantiles. Again, it is evident that the unilateral external prestressing of the container of borosilicate glass according to the invention also leads to a very distinct increase in strength of the container. Here, a container of alumino-silicate glass may experience an even higher increase in strength than a container of borosilicate glass.

The three last-mentioned tests, i.e. the tests in which the container was subjected to axial compression and diametrical or radial compression as well as the pendulum impact test, have shown that the strength of the container is distinctly improved.

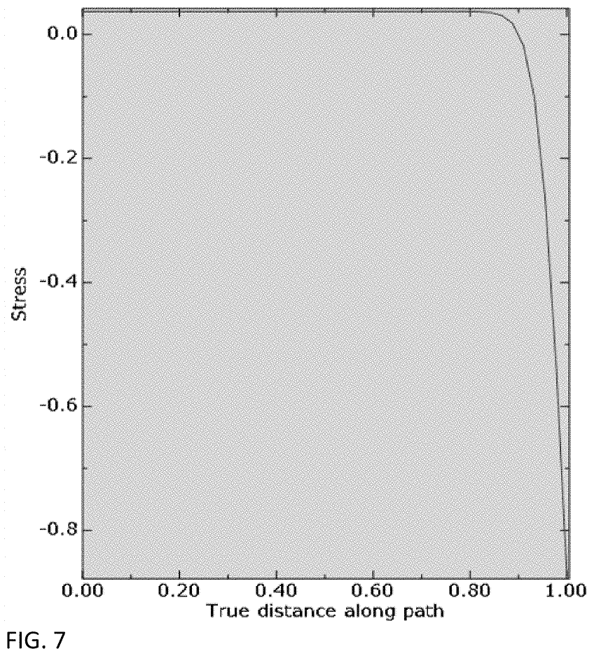

FIG. 7, by way of example, shows the stress patterns developing across the thickness of the wall as a result of unilateral prestressing. It is evident that the tensile stress CT, which typically occurs in the centre, i.e. in the vicinity of the middle 35 of the wall, continues as far as the inside surface of the wall of the container.

The formation of tensile stress on the inside surface of the wall is an essential characteristic for the strength of the container overall, in particular in the case of knocks from outside and axially or radially externally impacting forces, and the magnitude of this characteristic has a major influence on the strength. In terms of the invention it is advantageous, if the tensile stress on the inside surface of the wall does not become too great in order to prevent the burst pressure resistance from deteriorating.

In summary, an asymmetric profile of the stress pattern with regard to the middle of the wall develops in the wall, wherein the outer half of the wall, on average, comprises a (positive) compressive stress and the inner half of the wall comprises a (negative) tensile stress.

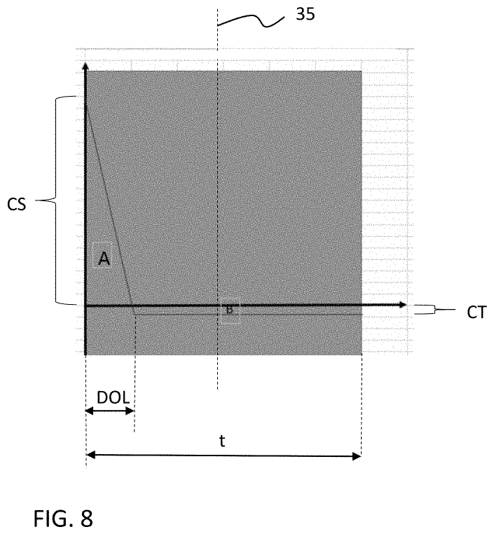

FIG. 8, by way of example, schematically shows the pattern of (positive) compressive stress and (negative) tensile stress in the wall. The stress pattern from the outside surface to the inside surface of the wall is depicted.

In a preferred embodiment a stress pattern exists in the wall 11 of the container 1, which starting from high compression prestressing on the outside surface transitions into a low level tensile stress in comparison thereto, which can be expressed as:

0.3*(CS×DOL)/(t−DOL)<IST<0.7*(CS×DOL)/(t−DOL).

As a result a container of glass can be made available which combines a very advantageous relationship of strength increases with only a very small decrease, if any, in regard of occurring internal pressure rises.

With this relationship as demonstrated above a reduction in burst pressure resistance of at most 20% can be accepted, where nevertheless outstanding increases in strength can be achieved, as has been demonstrated further above with reference to the measurements, the results of which were revealed in the form of respective 1% quantiles.

Here at least part of a tensile stress region on the inside surface of the wall may lie between IST>=0 MPa and IST<=30 MPa, preferably IST<=20 MPa, especially preferably IST<=15 MPa and most preferably IST<=5 MPa. In this way also it can be ensured that the tensile stress due to the prestressing does not become too great, so that the burst behaviour of the container 1 hardly deteriorates, or preferably does not deteriorate.

In the example, the tensile stress pattern from the middle 35 of the wall of the inventive container 1 up to the inside surface of the wall is constant, i.e. the level of tensile stress in the middle of the wall is approximately equal to the level of tensile stress on the inside surface of the wall. In a preferred embodiment the level of tensile stress in the middle of the wall up to the inside surface of the wall is subject to merely a small fluctuation, which preferably lies within a range of +/−10%, preferably +/−5%.

The container according to the invention is therefore also characterized in that only the outside surface of the wall has a near-surface compression-prestressed zone with a thickness DOL, which is not more than 15% in regard to the wall thickness, preferably not more than 10% and especially preferably not more than 8%.

In a very particularly preferred embodiment the thickness of the near-surface compression-prestressed zone on the outside surface of the wall is not more than 6% in regard to the thickness t of the wall. With a wall thickness of for example t=1.6 mm the thickness of the near-surface compression-prestressed zone is thus DOL=96 μm. As a result it can be achieved with a high degree of reliability that, especially in the case of chemical prestressing, that region which, due to the prestressing is changed in its composition and enriched with potassium ions, is limited to the outside surface.

The central region of the wall and an inner region extending from the middle of the wall to the inside surface of the wall are thus preferably free from additional alkalis introduced by the prestressing, preferably potassium ions. Generally speaking the distribution of alkalis introduced by the prestressing is monotonously decreasing from the outside surface towards the inside surface of the wall at least within a region which is remote by 0.5 μm from the outside surface up to a region which is remote by 0.5 μm from the inside surface.

The amount of K₂O and Na₂O on the inside surface of the wall is therefore preferably not more than 10%, preferably not more than 9% and especially preferably not more than 8%. According to the invention this amount is measured on the inside surface of the wall at a medium height viewed from the floor. To sum up therefore, a concentration pattern of alkali ions introduced by means of the exchange is present in the wall 11 shown in FIG. 2, which starting from a high value close to the outside surface of the wall decreases to a low value on the inside surface.

Therefore the big advantage of the invention is seen in that the inside surface of the container interacting with the medicine remains chemically unchanged and is therefore also chemically inert. This is advantageous in particular for containers which are provided for receiving a cosmetic, medical or pharmaceutical preparation.

At the same time the strength of the container according to the invention can be increased, so that product reliability of the container, in particular during transport and/or filling, can be distinctly improved. Moreover when the container is sealed, for example with a closure such as a plug, high internal pressures can occur, which can lead to bursting. Here too, the reliability of the container according to the invention can be improved.

According to the invention a pharmaceutical primary packaging of glass which is improved as regards strength can also be made available, in which the inside surface of the wall of the container which comes into contact with the preparation, for example the medicine, is chemically unchanged compared to the surface of a not prestressed container. The preparation, for example the medicine, is therefore also merely in contact with the original unchanged glass surface.

Different embodiments are suitable for the method depending on the intended amount of prestressing. If, for instance, only the floor and/or the heel and/or the sidewall are to be chemically unilaterally prestressed on the outside, i.e. essentially the portion of the container 1 denoted with A in FIG. 1, it is obvious to immerse the container 1, starting with the floor, in the saline bath. If the portion B of the container adjoining thereabove shall also further be chemically unilaterally externally prestressed, the container can, starting with the floor, be immersed more deeply into the saline bath, wherein however care should be taken that the saline bath does not enter into the opening so as to prevent the inside surface of the container from being chemically changed. To this end the opening is conveniently sealed, for example with a plug.

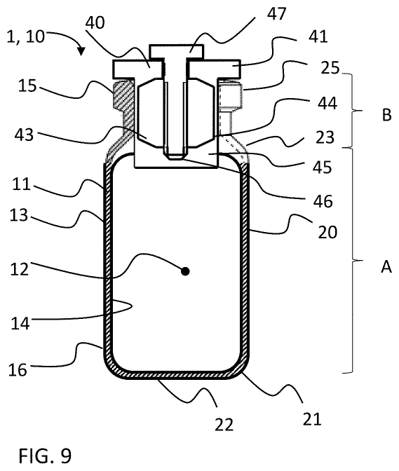

An exemplary plug is shown in FIG. 9, in which a stainless steel body 40 with a lateral overhang 41, the body being in the cross-section essentially T-shaped and respectively in sections, cylindrical, is inserted into the opening of the container 1, in particular a small bottle 10. In its interior the stainless steel body 40 comprises a recess 42, which comprises a sidewall region 44 with a reduced wall thickness of approximately 10 to 100 μm thick. The sidewall region 44 comprises an outwardly arched convexity which is hardly recognizable in FIG. 9 and which allows the insertion thereof into the container having an elastic lateral support in the opening 17 against the container 1.

The floor 45 of the stainless steel body 40 comprises a blind bore hole 46 with an internal thread, which is engaged by the external thread of a threaded pin 47, comprising a laterally overhanging head part.

By twisting the threaded pin 47 the stainless steel body 40 can be compressed and as twisting increases, the stainless steel body 40 is pressed increasingly tightly against the sidewall region 44 on the glass of the container 1 until sufficiently fluid-tight contact has been achieved in regard to the above-described chemical hardening. This position of fluid-tight contact is shown in FIG. 9.

This process of inserting the stainless steel body and of producing a fluid-tight contact can be performed either manually or else with the aid of automated process tools.

If this process is performed as part of an automated production process, the stainless steel body 40, in particular also its lateral overhang 41, can serve as a holder for the container 1, which is already attached directly after the hot-moulding on the same and is not detached from it until at the end of the treatment and processing process, in particular not until after prestressing has been performed. In this way the container 1 can be reliably protected against mechanical loads impacting its surface during manufacture or transport.

Another embodiment provides for immersing the container, head first, in a direction of movement parallel to the longitudinal axis of the container and perpendicular to the surface of the saline bath, so that due to the air present in the hollow body the saline solution can be prevented from entering the hollow body.

What is claimed is:

1. A container of glass, comprising:
a hollow body having has an internal volume and a wall, the wall having an inside surface that borders the internal volume and an outside surface opposite the inside surface; and
a zone of compressive stress (CS) in the wall at the outside surface so that the outside surface is compression-prestressed at least in a partial region, wherein the wall at the inside surface opposite the partial region is free from compressive stresses.

2. The container of claim 1, wherein the wall has a middle between the outside surface and the inside surface, and wherein the middle has a tensile stress (CT) that is greater than or equal to 0 MPa and less than or equal to 20 MPa.

3. The container of claim 2, wherein the wall at the inside surface opposite the partial region is under tensile stress (IST).

4. The container of claim 2, wherein the tensile stress in the middle is within a range of +/−10% of the tensile stress at the inside surface.

5. The container of claim 1, wherein the wall further comprises a feature selected from a group consisting of an opening, a rolled edging, a neck, a shoulder, a heel, a floor, and any combinations thereof.

6. The container of claim 5, the zone of compressive stress is formed adjacent to the feature.

7. The container of claim 1, wherein the hollow body is a body selected from a group consisting of a bottle, an ampoule, a syringe, and a cartridge.

8. The container of claim 1, wherein the inside surface has a tensile stress (IST) that is greater than or equal to 0 MPa and less than or equal to 30 MPa.

9. The container of claim 8, wherein the zone of compressive stress (CS) in the wall at the outside surface and the tensile stress (IST) at the inside surface satisfy:
0.3*(CS×DOL)/(t−DOL)<IST<0.7*(CS×DOL)/(t−DOL),
wherein DOL denotes a depth of the zone of compressive stress, t denotes a thickness of the wall, CS denotes compressive stress on the outside surface, and IST the tensile stress (IST) at the inside surface.

10. The container of claim 1, wherein the zone of compressive stress has a depth that is not more than 15% of a thickness of the wall.

11. The container of claim 1, wherein the zone of compressive stress has an alkali content that monotonously decreasing from a region remote by 0.5 μm from the outside surface up to a region remote by 0.5 μm from the inside surface.

12. The container of claim 1, wherein the wall at the inside surface is free from an additional concentration of alkali species introduced by the zone of compressive stress up to a depth of at least 100 μm from the inside surface.

13. The container of claim 12, wherein the depth is up to at least 200 μm.

14. The container of claim 1, wherein the wall at the inside surface has a region at least opposite the partial region that has an average content of K₂O+Na₂O up to a depth of 500 μm that is not more than 13% by weight.

15. The container of claim 1, wherein the zone of compressive stress (CS) a thermal zone of compressive stress or a chemical zone of compressive stress.

16. The container of claim 1, wherein the container comprises a borosilicate glass or an alumino-silicate glass.

17. A container of glass, comprising:
a hollow body made of a borosilicate glass or an alumino-silicate glass, the hollow body being a shape selected from a group consisting of a bottle, an ampoule, a syringe, and a cartridge, the hollow body having an internal volume, an inside surface that borders the internal volume, and an outside surface opposite the inside surface; and
a zone of compressive stress (CS) formed from a concentration of alkali species in the outside surface,
wherein the inside surface is free from compressive stresses and is free from the concentration of alkali species up to a depth of at least 100 μm from the inside surface.

18. The container of claim 17, wherein the wall has a middle between the outside surface and the inside surface, and wherein the middle has a tensile stress (CT).

19. The container of claim 17, wherein the inside surface opposite the zone of compressive stress is under tensile stress (IST).

20. The container of claim 17, wherein the hollow body further comprises a feature selected from a group consisting of an opening, a rolled edging, a neck, a shoulder, a heel, a floor, and any combinations thereof, the zone of compressive stress being formed only up to the feature.

21. A method for chemically prestressing a container of glass, comprising:
immersing only an outside surface of a glass hollow body in a saline bath comprising potassium nitrate (KNO₃) at a temperature of at least 400° C. and below a glass-transition temperature of the glass hollow body for a duration of 1 to 24 hours so that a compressive stress is generated only on the outside surface.

22. The method of claim 21, further comprising sealing an opening of the hollow glass body prior to the immersing step.
